(19) United States
(12) Patent Application Publication
(10) Pub. No.: US 2015/0004972 A1
(43) Pub. Date: Jan. 1, 2015

(54) METHOD AND APPARATUS FOR MANAGING CARRIERS

(71) Applicants: NOKIA CORPORATION, Espoo (FI); NOKIA SIEMENS NETWORKS OY, Espoo (FI)

(72) Inventors: Sari Nielsen, Espoo (FI); Antti Toskala, Espoo (FI)

(21) Appl. No.: 14/376,442

(22) PCT Filed: Jan. 23, 2013
(86) PCT No.: PCT/FI2013/050072

§ 371 Date: Aug. 4, 2014

Related U.S. Application Data
(63) Continuation-in-part of application No. PCT/FI2012/050106, filed on Feb. 3, 2012.

(51) Int. Cl. H04W 48/16

(52) U.S. Cl. CPC H04W 48/16; H04W 56/001
USPC 455/434

(57) ABSTRACT

In accordance with an example embodiment of the present invention, there is provided an apparatus, comprising a receiver configured to receive information from a serving cell, the receiver being further configured to receive a primary synchronization signal and a secondary synchronization signal from a second cell, memory circuitry configured to access stored information enabling the apparatus to derive an identity of the second cell based on the primary synchronization signal and the secondary synchronization signal, the memory further being configured to access stored information on a first frequency used by the serving cell and a second frequency used by the second cell, and at least one processing core configured to cause a transmitter comprised in the apparatus to perform transmitting the identity of the second cell, the transmitting being directed to the serving cell.

### TECHNICAL FIELD

The present application relates generally to cellular and multi-carrier communication.

### BACKGROUND

Wireless communication between electronic devices requires that devices participating in the communication, for example a base station and a mobile station, are configured to conform to an agreed framework for communication. The agreed framework comprises procedures that are used to effect the communication in the framework context, wherein the context may comprise for example air interface resources, or radio resources, such as at least one frequency band. Such frameworks may be known as radio access technologies, or RATs. A RAT may be defined in industry standards that device manufacturers can refer to when designing products such that they are capable of communicating according to the RAT.

When standards are used correctly, interoperability between devices from a plurality of suppliers may be achieved. For example, a cellular telephone produced by a first manufacturer may be capable of communicating with a cellular telephone produced by a second manufacturer, using a base station produced by a third manufacturer and a core network produced by a fourth manufacturer.

Radio access technologies may be designed for specific use cases in mind For example, cellular telephony RATs may be optimized for ease of roaming, wide-area coverage and battery power efficiency. On the other hand, other RATs such as those designed for wireless hotspots for stationary users may be optimized to produce high peak datarates in the network to mobile direction.

To increase communication rates in cellular communication, it has been proposed that mobile stations be rendered capable of communicating simultaneously using more than one carrier, by which it is meant that a a plurality of carriers, separated from each other in frequency, are used simultaneously to convey information between a network and a mobile station. The mobile station may be configured to compile, or aggregate, information conveyed over the plurality of carriers into a single file or stream, thus effectively multiplying the data transmission capability of a single carrier.

Carriers comprised in a carrier aggregation may be known as component carriers, wherein one of the component carriers may be considered a primary carrier and other carriers may be considered secondary carriers. Component carriers terminating in a given mobile station may originate in one cell or in a plurality of cells. Where a plurality of cells are involved, the cell associated with the primary carrier may be known as a primary cell, PCell, and cells associates with secondary carriers may be known as secondary cells, SCells.

### SUMMARY

Various aspects of examples of the invention are set out in the claims.

According to a first aspect of the present invention, there is provided an apparatus, comprising a receiver configured to receive information from a serving cell, the receiver being further configured to receive a primary synchronization signal and a secondary synchronization signal from a second cell, memory circuitry configured to access stored information enabling the apparatus to derive an identity of the second cell based on the primary synchronization signal and the secondary synchronization signal, the memory further being configured to access stored information on a first frequency used by the serving cell and a second frequency used by the second cell, and at least one processing core configured to cause a transmitter comprised in the apparatus to perform transmitting the identity of the second cell, the transmitting being directed to the serving cell.

According to a second aspect of the present invention, there is provided a method, comprising receiving information from a serving cell, receiving a primary synchronization signal and a secondary synchronization signal from a second cell, accessing stored information enabling the apparatus to derive an identity of the second cell based on the primary synchronization signal and the secondary synchronization signal, and accessing stored information on a first frequency used by the serving cell and a second frequency used by the second cell, and transmitting the identity of the second cell, the transmitting being directed to the serving cell.

According to a third aspect of the present invention, there is provided an apparatus, comprising at least one processor, at least one memory including computer program code, the at least one memory and the computer program code configured to, with the at least one processor, cause the apparatus to transmit to a user equipment information enabling the user equipment to derive an identity of a cell based on a primary synchronization signal and a secondary synchronization signal of the cell, receive an identity of the cell from the user equipment, and transmit to the user equipment an instruction to to begin communicating with the apparatus and the cell using a carrier aggregation such that a primary carrier conveys information between the user equipment and the apparatus and a secondary carrier conveys information between the apparatus and the cell.

According to further aspects of the invention there are provided methods for operating apparatuses configured to implement the invention, and computer programs configured to cause said methods to be performed.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system capable of supporting at least some embodiments of the invention;

FIG. 2 illustrates schematically carriers that may be used in carrier aggregation according to at least some embodiments of the invention;

FIG. 3 illustrates a block diagram of an apparatus in accordance with an example embodiment of the invention;

FIG. 4 is a first flowchart illustrating a method according to at least some embodiments of the invention;

FIG. 5 is a second flowchart illustrating a method according to at least some embodiments of the invention, and

FIG. 6 is a third flowchart illustrating a method according to at least some embodiments of the invention.

### DETAILED DESCRIPTION OF THE DRAWINGS

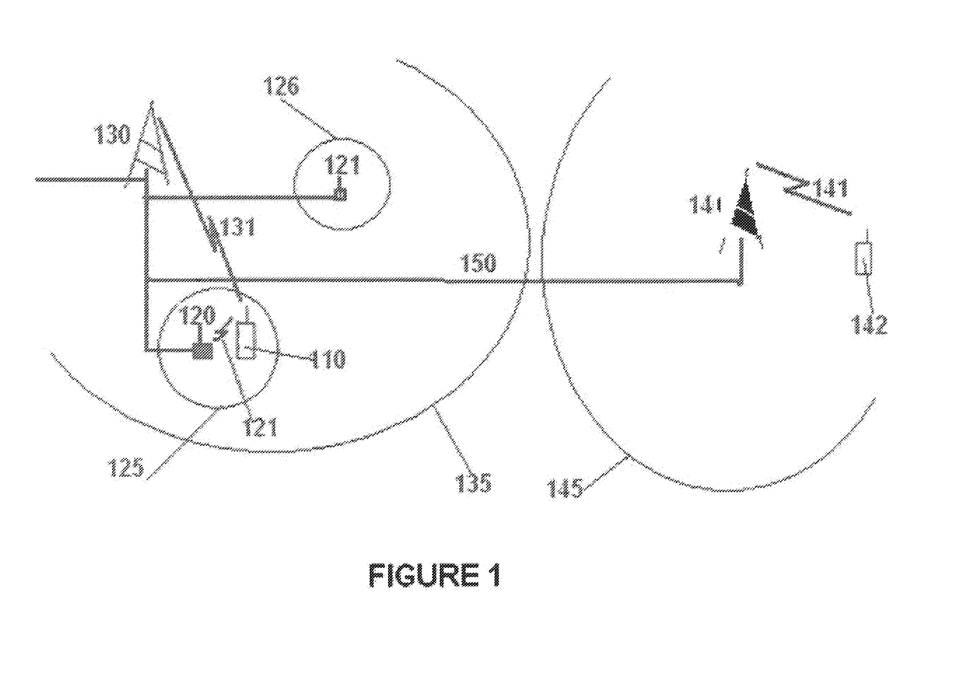

An example embodiment of the present invention and its potential advantages are understood by referring to FIGS. 1 through 6 of the drawings.

FIG. 1 illustrates an example system capable of supporting at least some embodiments of the invention. The system comprises mobile 110, which may be a cellular telephone, personal digital assistant, PDA, cellular telephone, tablet computer or another kind of device, for example. Base stations 130 and 140 may be configured to operate according to at least one cellular standard, such as global system for mobile communication, GSM, wideband code division multiple access, WCDMA or long term evolution, LTE, for example. Base station 120 may be considered to control a cell of its own. Base stations 130 and 140 may be configured to communicate using a pre-defined band of licensed spectrum, which has been allocated by authorities for cellular communication. Base station 120 and its cell 125 may operate according to wireless local area network, WLAN, or worldwide interoperability for microwave access, WiMAX, technologies, for example, or according to a cellular standard like cells 135 and 145, which are controlled by base stations 130 and 140, respectively. Base station 120 may be configured to control a small cell 125. Small cell 125 may be considered to be a smaller cell when compared to cells 135 and 145. Small cell 125 may operate using the same technology as cells 135 and 145, and small cell 125 may be comprised in the same network as cells 135 and 145. Base station 121 may be configured to control a further small cell 126. Examples of small cells include femtocells, closed subscriber group, CSG, cells and pico cells. In some embodiments, base stations 120 and 121 are mobile devices.

Mobiles may roam from location to location, and depending on measurements of signal strength or signal quality between mobile and base station, mobiles may change from communicating with a first base station, such as base station 130, to communicating with another base station, such as base station 140. Such a change may be known as a handover or handoff. In one form of handover, known as soft handover, a mobile may change from communicating with base station 130 only to communicating with base station 130 and base station 140, for example. A set of base stations with which a mobile communicates simultaneously may be known as an active set.

Small cell 125 may be configured to provide additional coverage for a subset of users, such as premium users or emergency services users. Small cell 125 may be configured to provide services that are not available in other cells, such as cells 135 and 145. Small cell 125 may provide a location estimate to users allowed to attach to it since small cell 125 may be a relatively small cell. Calls and connections from small cell 125 may be given preferential access to taxi centres, service numbers and/or intranet/extranet services, for example. In some embodiments small cell 125 is open to all users, and the network in which it and cell 135 are comprised in may be configured to offload certain types of traffic from cell 135 to small cell 125 for users in the cell coverage area of small cell 125. Similar considerations may apply to further small cell 126. A mobile may be capable of determining that a cell is a small cell based on, for example, the radio access technology used, broadcast information from the cell indicating its size or type, indication from the network that a certain cell IDs, or ranges of cell IDs, are small cells, or an indication that a certain carrier has small cells. While cell 125 and cell 126 are discussed above as small cells, in some embodiments there cells are not particularly small and may be similar to cell 135 and cell 145, for example.

Mobile 110 may be capable of communicating with at least one cellular protocol used by base stations 120, 121, 130 and/or 140. FIG. 1 illustrates further mobile 142 in wireless communication with base station 140. Wireless link 141 interconnects further mobile 142 and base station 140. Wireless link 141 may comprise a downlink for conveying information from base station 140 to further mobile 142. Wireless link 141 may comprise an uplink for conveying information from further mobile 142 to base station 140. Both uplink and downlink may convey control information and data. The uplink and/or downlink may each comprise more than one logical channel. The uplink and/or downlink may each comprise more than one physical channel. Wireless link 141 may conform to a cellular communication standard, for example. Wireless link 141 may be based on GSM, WCDMA, LTE or another standard. Wireless link 141 may be based on orthogonal frequency division multiple access, OFDMA, code division multiple access, CDMA, time divisions multiple access, TDMA, or a combination of these, for example. Wireless links between mobiles and base stations 130, 120 and 121 may be substantially similar to wireless link 141. Alternatively a network comprising base stations 120, 121, 130 and 140 may be multi-standard in the sense that base stations comprised therein do not all conform to the same radio access technology, RAT.

Base stations 120, 121, 130 and 140 are in the example system of FIG. 1 interconnected by a backbone network 150. In this example, backbone network 150 is further connected to other parts of the cellular network in which base stations 120, 121, 130 and 140 are comprised. The cellular network, or more generally the network, may comprise in addition to base stations various nodes such as switches, mobility management entities, MMEs, serving gateways, SGWs, base station controllers and the like, depending on the embodiment and type of network.

Mobile 110 is illustrated in FIG. 1 as being in communication with cell 135 by means of wireless link 131 to base station 130. Mobile 110 is illustrated in FIG. 1 as being in communication with cell 121 by means of wireless link 121 to base station 120. Wireless links 131 and 121 may comprise an uplink and/or downlink much like wireless link 141. A wireless link may comprise at least one component carrier. For example, wireless link 131 may comprise two component carriers, separated in frequency, interconnecting mobile 110 and base station 130. Similarly wireless link 121 may comprise at least one component carrier interconnecting mobile 110 and base station 120. Since mobile 110 is illustrated as being in the cell coverage areas of both cell 125 and cell 135, mobile 110 is reachable over an air interface to both base station 130 and base station 120.

Where mobile 110 and the network where base stations 130 and 120 are comprised in are capable of supporting carrier aggregation solutions, mobile 110 may communicate with the network using a carrier aggregation that comprises at least one carrier on wireless link 131 and at least one carrier on wireless link 121. Wireless link 121 and wireless link 131 may occupy frequency bands that are distinct from each other, for example wireless link 131 may occupy frequency bands used to provide large-scale nationwide cellular coverage. Wireless link 121 may occupy frequency bands used to provide local coverage to supplement large-scale coverage.

While cell 125 has been discussed as a small cell, the scope of the invention also includes carrier aggregation solutions, including aggregation solutions across distinct frequency allocations, between large cells.

Taking a LTE system as an example, cells may normally be configured to transmit a number of broadcasted signals such as, for example, a cell specific reference signal, CRS, a primary synchronization signal, PSS, and a secondary synchronization signal, SSS, signals. Other systems than LTE may have transmissions with similar names and/or functions.

A mobile searching for cells may first rely on a PSS signal transmitted by a cell to obtain synchronization with the cell. A PSS signal may be designed to have a low autocorrelation with non-zero delay, allowing a mobile to determine the timing corresponding to slot boundaries of the cell. With a low autocorrelation with non-zero delay it is meant that an autocorrelation function of the PSS signal may be essentially zero at all offset values except zero, where the function may display a sharp peak. A mobile may search for the peak by correlating a received signal with a sequence configured in or derived by the mobile. A PSS may be arranged to convey a first partial identity of the cell. In some embodiments mobile 110 may be configured to decide based on the first partial identity whether to search for a SSS from the cell. Mobile 110 may be configured to only search for SSS signals from cells with first partial identities fulfilling a pre-determined criterion, for example that the first partial identity is comprised in a list stored in mobile 110.

After determining a slot boundary timing using a PSS, a mobile may be configured to determine a frame boundary using an SSS signal. An SSS signal may be, for example, a random or pseudorandom bit sequence embedded in a transmission from the cell, which the mobile is configured to understand to determine frame boundaries, wherein a frame may comprise a plurality of slots. A SSS may be arranged to convey a second partial identity of the cell. Depending on the embodiment, PSS and SSS may be transmitted on different physical or logical channels, or alternatively on the same channel. Where PSS and SSS are transmitted on the same channel, symbols associated with PSS may be transmitted at a different time than symbols associated with SSS.

A first partial identity, obtained from PSS, and a second partial identity, obtained from SSS, together may determine a physical layer identity of the cell.

A CRS signal transmitted from the cell may also be arranged to convey the physical layer identity of the cell. After synchronizing using PSS and SSS, a mobile may be configured to derive the physical layer identity of the cell from CRS, and compare it to the physical layer identity of the cell derived from PSS and SSS together. If the identities match, the mobile may be confident that no physical layer identity detection error occurred in the derivation of the identity, and the mobile may be configured to report to the network that it has discovered a cell with the derived identity. Whereas PSS and SSS are discussed in this document, it is to be understood that the scope of the invention also encompasses embodiments where there is configured a single physical synchronization channel, capable of conveying a cell identity or similar information which identifies the transmission network access node, such as for example a base station.

In cases where cell 125 is a small cell, in particular a small cell operating on a different frequency band than cell 135, it may be beneficial to partially disable normal transmissions from cell 125. For example, if there are long periods of time during which cell 125 doesn't serve any mobiles, cell 125 may be configured to partially suppress the transmission of at least one control signal that base stations normally transmit in the network where cell 125 is comprised. For example, a cell may discontinue transmitting the CRS when no mobiles are attached to it. Benefits of discontinuing transmission of certain signals include conservation of power, and reduction in air interface interference to other signals.

Where mobile 110 is attached to cell 135, for example, mobile 110 may be configured to transmit uplink physical layer feedback to cell 135. Examples of uplink physical layer feedback include acknowledgements, ACK/NACK, and channel quality indications, CQIs, which reflect a quality of a downlink signal received from base station 130. When mobile is attached to cell 135 there may also exist a radio resource control, RRC, connection between mobile 110 and base station 130. When mobile 110 is thus attached to cell 135, cell 135 may be considered a serving cell for mobile 110.

Mobile 110 may be configured to receive information from its serving cell that there exists at least one cell nearby, or within the cell coverage area of the serving cell, which has suppressed sending at least some control signals. For example, the information may explicitly or implicitly indicate that the at least one cell has suppressed sending CRS. The information may comprise an indication of a frequency band where the at least one cell operates. The indicated frequency band may be different from a frequency band used by the serving cell. The information may indicate the at least one cell comprises at least one small cell. The information may comprise location information relating to the at least one small cell to facilitate finding of the at least one small cell.

Responsive to receiving the information, mobile 110 may be configured to store in an internal memory comprised in mobile 110 at least part of the received information. Responsive to the information, mobile 110 may be configured to search for the at least one cell, for example by searching for PSS and SSS signals on an indicated frequency band. Responsive to detecting the PSS and SSS signals, mobile 110 may be configured to derive a physical layer identity of the cell, such as cell 125, and to report the derived physical layer identity to the serving cell, for example cell 135. Since the newly discovered cell doesn't transmit CRS, mobile 110 cannot use CRS to verify the received physical layer identity is correct. In some embodiments, mobile 110 is configured to perform a signal strength and/or quality measurement based on the received PSS and/or SSS signals. This measurement may correspond, for example, to a determined height of a correlation result when determining synchronization in mobile 110, either as a maximum value or as a combined and/or averaged result, or another signal strength metric derived based on the received PSS and/or SSS signals. Results of this measurement may be reported to the network.

Upon receiving the report comprising the derived physical layer identity, base station 130 may be configured to communicate with the base station associated with the physical layer identity to cause the base station to begin transmitting CRS, to enable mobile 110 to verify the correctness of the derived identity and perform CRS based measurements like received signal received power, RSRP, and received signal received quality, RSRQ, if requested by the base station, for example. Since the identity derived from PSS and SSS may be incorrect, base station 130 may be configured to cause all cells that are nearby or within the cell coverage area of cell 135 to begin transmitting CRS. Alternatively, base station 130 may be configured to determine which cell nearby or within the cell coverage area of cell 135 corresponds to the derived identity. Where the identity was correctly derived in mobile 110 this corresponds to identifying the cell on the basis of the identity. Where mobile 110 didn't correctly derive the identity, in other words where the derived identity doesn't match any cell nearby or withing the coverage area of cell 135 not transmitting CRS, base station 135 may activate CRS transmission in all nearby cells or it may match the derived identity to an identity of a suitable cell that is nearby or within the coverage area of cell 135, and not transmitting CRS. Matching in this sense may comprise, for example, determining an existing cell identity that differs from the derived identity by only one bit. In cases where there exists only one cell not transmitting CRS nearby or or withing the coverage area of cell 135, the task of base station 130 becomes easy as base station 130 can determine that whatever identity mobile 110 reports based on PSS and SSS, it necessarily must refer to that cell. Mobile 110 may be configuired to indicate when reporting an identity to the serving cell, whether the identity was derived by mobile 110 only from synchronization signals, such as PSS and SSS.

Once mobile 110 begins receiving CRS from the discovered cell, mobile 110 may be configured to perform measurements of the discovered cell based on CRS. Examples of such measurements may include received signal received power, RSRP, and received signal received quality, RSRQ, measurements. Mobile 110 may also verify the derived physical layer identity of the discovered cell by re-deriving it from CRS, and subsequently use the identity derived from CRS in signaling in case it differs from that derived earlier from PSS and SSS.

After the discovered cell has been activated to send CRS and measured by mobile 110, it may be a candidate to become a SCell in a carrier aggregation communication where the serving cell assumes the role of PCell. In other words, the discovered cell may be in partial hibernation, from which it can be activated to serve as a secondary cell in carrier aggregation if needed.

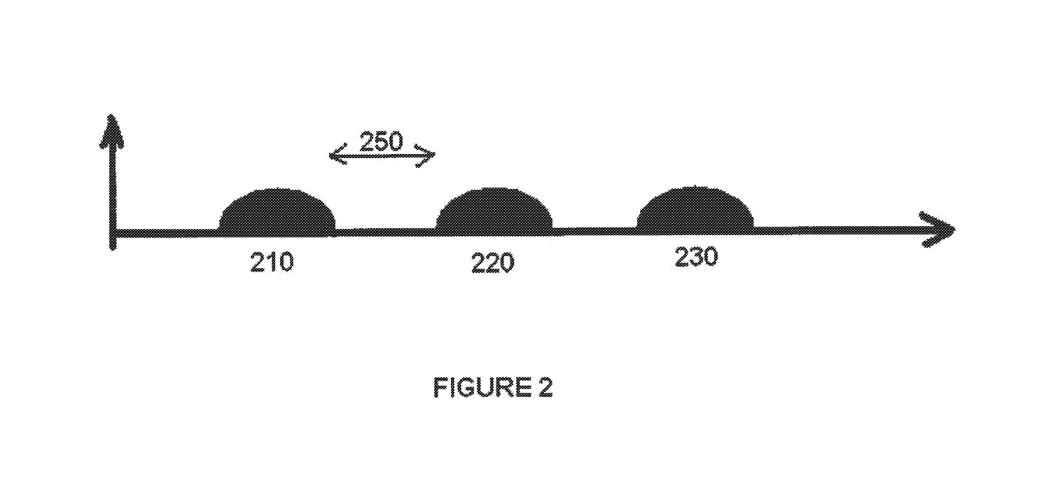

FIG. 2 illustrates schematically carriers that may be used in carrier aggregation according to at least some embodiments of the invention. FIG. 2 illustrates a coordinate system wherein frequency increases from left to right, and energy increases from the bottom toward the top. Along the horizontal frequency axis are illustrated component carriers 210, 220 and 230 which are separated from each other in frequency space. The frequency separation between the component carriers is illustrated as 250 in the figure. Assuming that component carrier 210 can convey a certain bitrate between a base station and a mobile, aggregating three similar carriers will effectively triple the aggregate bitrate. However, as can be seen from the Figure, energy and frequency resources allocated to the connection will also triple in this example. In some embodiments, component carriers in a carrier aggregation are not identical, or even similar, to each other, it is for example possible that component carriers in a carrier aggregation are dissimilar in capacity, energy requirements, frequency band width and modulation technique, for example. Component carriers may be adjacent in the frequency band, in other words the frequency separation 250 may be essentially non-existent, or component carriers may be on entirely different frequency bands. For example, one component carrier may be on a 2.1 GHz frequency band and another can be on a 3.5 GHz frequency band.

In general there is provided an apparatus, for example mobile 110 or a control device, such as chipset or other at least one integrated circuit, for inclusion in mobile 110 to control the functions of mobile 110.

The apparatus may comprise a receiver configured to receive information from a serving cell, the receiver being further configured to receive a primary synchronization signal and a secondary synchronization signal from a second cell. Where the apparatus is mobile 110, the receiver may comprise a radio transceiver comprised in mobile 110. Where the apparatus is a control apparatus, the receiver may comprise a serial port and pin, for example, of the control device and receiving may comprise receiving information from the cells via a radio transceiver comprised in a mobile 110, conveyed internally in mobile 110 to the receiver of the control device. Information from a serving cell may comprise at least one of user data and signaling, such as for example RRC signaling. In an embodiment, the primary and secondary synchronization signals are in accordance with long term evolution standards.

The apparatus may further comprise at least one memory circuitry configured to access stored information enabling the apparatus to derive an identity of the second cell based on the primary synchronization signal and the secondary synchronization signal, the memory circuitry further being configured to access stored information on a first frequency used by the serving cell and a second frequency used by the second cell. Where the apparatus corresponds to mobile 110, the memory circuitry may be comprised in the mobile, and where the apparatus corresponds to a control device, the memory circuitry may be arranged in the control device to access memory that is internal to the control device, or alternatively memory that is outside the control device in mobile 110. The stored information may comprise information indicating that at least one cell fulfilling certain criteria will not transmit certain control information, for example CRS, and therefore an identity of the at least one cell must be derived from the primary synchronization signal and the secondary synchronization signal alone. The criteria may comprise, for example, an indication as to an operating frequency range that comprises an operating frequency of the at least one cell. The information on frequencies used by cells may be expressed in various formats, for example in megahertz units, or by using an appropriate channel numbering scheme wherein there exists a mapping from channel numbers to frequencies. The criteria may alternatively to a frequency range identify at least one single frequency used by at least one cell.

The apparatus may further comprise at least one processing core configured to cause a transmitter comprised in the apparatus to perform transmitting the identity of the second cell, the transmitting being directed to the serving cell. Where the apparatus corresponds to mobile 110, the at least one processing core may be comprised in a control device comprised in mobile 110. Where the apparatus corresponds to a control device, the control device may comprise the at least one processing core, wherein the at least one processing core is configured to cause the control device to cause a radio transmitter comprised in a mobile 110 to transmit the identity of the second cell to the serving cell. The control device may be configured to cause the radio transmitter of mobile 110 to transmit by effecting signaling internally in mobile 110, using electrical leads arranged between an input/output circuitry of the control device, such as for example serial port and pin, and the radio transmitter of mobile 110, for example. The internal signaling may comprise the identity and control information adapted to cause the radio transmitter to transmit the identity to the serving cell. The identity may be an identity derived from the primary synchronization signal and the secondary synchronization signal, expressed in a suitable format, for example a physical cell identity numbering format.

In some embodiments, the apparatus is configured to derive the identity of the second cell based on the primary synchronization signal and the secondary synchronization signal without using a cell specific reference signal transmitted by the second cell. This may comprise deriving the identity from the primary and secondary synchronization signals and not confirming the correctness of the derived identity by re-deriving the identity from a cell specific reference signal. The apparatus may be configured to not use a cell specific reference signal for deriving the identity responsive to determining that the information enabling the deriving of a cell identity based on the primary and secondary synchronization signals applies to the second cell, for example by identifying an operating frequency band or operating frequency of the second cell. Deriving may be performed, for example, by the at least one processing core.

In some embodiments, the apparatus is configured to cause at least one of a signal power measurement and a signal quality measurement to be performed on the second cell based on at least one of the primary synchronization signal and the secondary synchronization signal. The apparatus may be configured to report a result, or cause a result to be reported, of the at least one of a signal power measurement and a signal quality measurement to the serving cell.

In some embodiments, the apparatus is configured to perform, or to cause to be performed, at least one of a signal power measurement and a signal quality measurement based on a cell specific reference signal from the second cell. The apparatus may be configured to perform this measurement, or cause it to be performed, after performing a similar measurement using at least one of the primary synchronization signal and the secondary synchronization signal.

In some embodiments, the apparatus is configured to perform, or to cause to be performed, at least one of a signal power measurement and a signal quality measurement based on a cell specific reference signal from the second cell responsive to having transmitted, or caused to be transmitted, the identity of the second cell toward the serving cell.

In some embodiments, the apparatus is configured to perform, or to cause to be performed, at least one of a signal power measurement and a signal quality measurement based on a cell specific reference signal from the second cell responsive to receiving, from the serving cell, an indication as to when the second cell will begin transmitting a cell specific reference signal. The serving cell may transmit the indication responsive to receiving an identity of the second cell, derived from the primary synchronization signal and the secondary synchronization signal, from mobile 110, for example, wherein the serving cell may cause the second cell to begin transmitting the cell specific reference signal responsive to receiving the identity from mobile 110.

In some embodiments, the apparatus is configured to participate in causing a carrier aggregation communication to be effected between the apparatus, the serving cell and the second cell, wherein a primary carrier conveys information between the apparatus and the serving cell and a secondary carrier conveys information between the apparatus and the second cell. The carrier aggregation may be configured responsive to successfully identifying the second cell and causing the second cell to begin transmitting a cell specific reference signal.

In some embodiments, the carrier aggregation may be configured responsive to reporting a result of a signal power or quality measurement based on the cell specific reference symbols from the second cell, the reporting being directed to the serving cell.

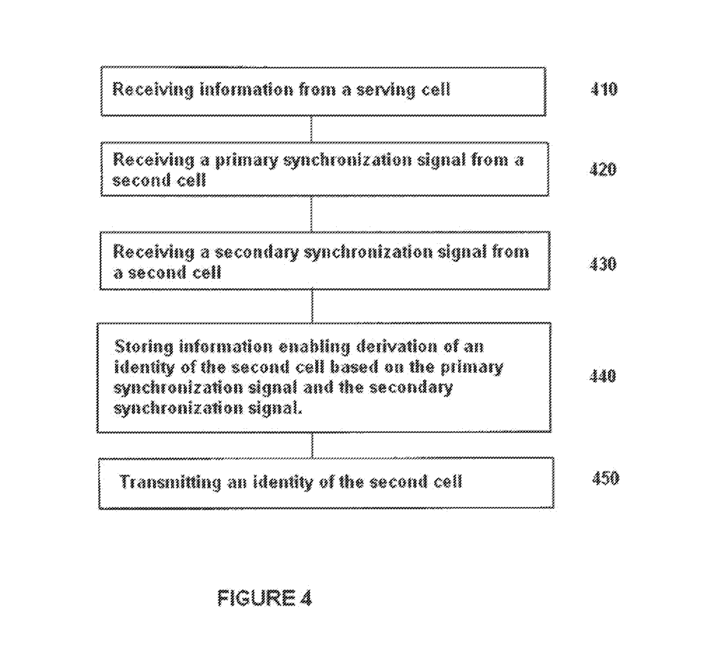

FIG. 4 is a first flowchart illustrating a method according to at least some embodiments of the invention. The method may be performed in mobile 110, for example. In phase 410, information is received from a serving cell, wherein a serving cell may be a cell with which there exists a RRC connection. The information may be user data or signaling, for example. In phases 420 and 430, a primary synchronization signal and a secondary synchronization signal are received from a second cell, wherein the second cell may be, for example a small cell contained within a cell coverage area of the serving cell or alternatively a non-small cell. In phase 440, stored information is accessed which enables derivation of an identity of the second cell based on the primary synchronization signal and the secondary synchronization signal, for example based exclusively on these two signals without resorting to a cell specific reference signal from the second cell. In phase 450, an identity derived based on the primary synchronization signal and the secondary synchronization signal is transmitted, or caused to be transmitted, toward the serving cell.

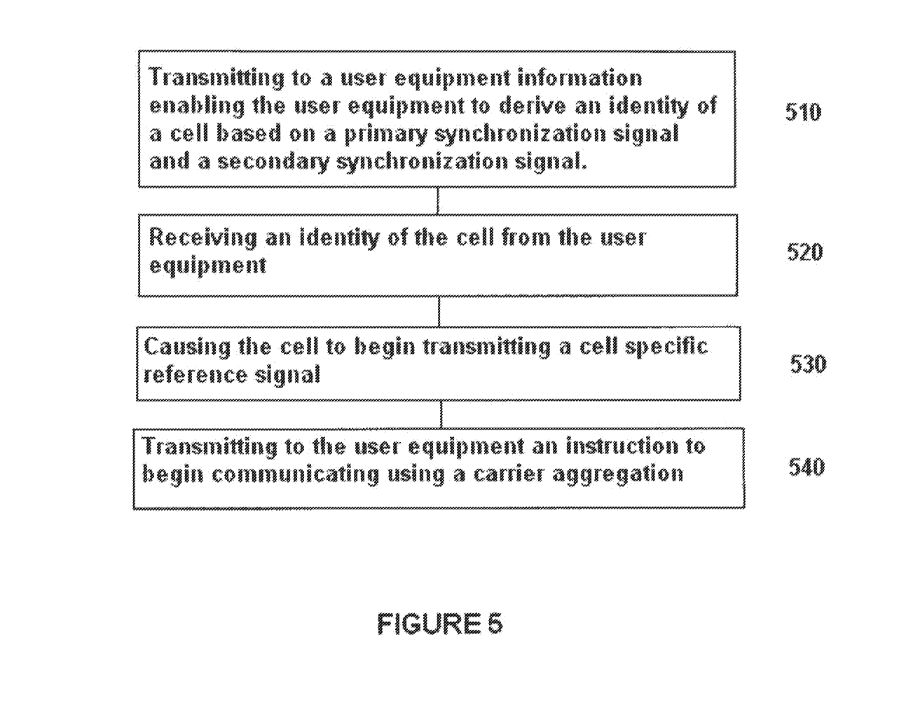

FIG. 5 is a second flowchart illustrating a method according to at least some embodiments of the invention. The method may be performed in base station 130, for example, operating as a serving base station for mobile 110. In phase 510, information is transmitted to a user equipment such as, for example, mobile 110, the information enabling the user equipment to derive an identity of at least one cell based on a primary synchronization signal and a secondary synchronization signal. The information may enable deriving the identity based exclusively on the primary synchronization signal and the secondary synchronization signal, for example without using a cell specific reference signal. In phase 520, an identity of a cell is received from the user equipment, wherein the user equipment may have derived the identity without using a cell specific reference signal. The received identity may not be entirely correct in the sense that there may be, for example, an isolated bit error in the identity. Responsive to receiving the identity, the cell the identity corresponds to may be caused to begin transmitting cell specific reference signals, phase 530, and the user equipment may optionally be informed of a time, when the identified cell will begin transmitting a cell specific reference signal. Alternatively the user equipment may be informed of the fact that the identified cell has begun transmitting a cell specific reference signal. Possible errors in the received identity can be dealt with as described above. In phase 540, an instruction may be transmitted to the user equipment instructing the user equipment to begin communicating using a carrier aggregation that comprises, for example, a primary carrier to the apparatus implementing the method of FIG. 5 and a secondary carrier to the cell the received identity pertains to.

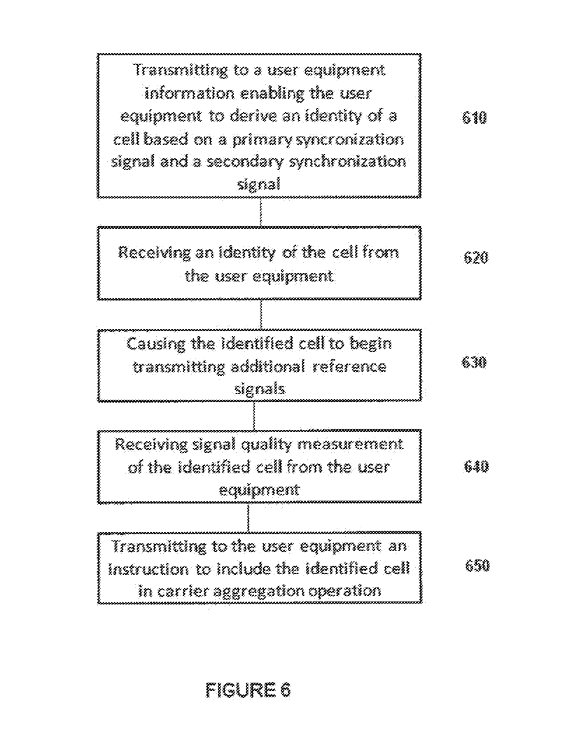

FIG. 6 is a third flowchart illustrating a method according to at least some embodiments of the invention. The method may be performed in base station 130, for example, operating as a serving base station for mobile 110. The method of FIG. 6 resembles the method illustrated in FIG. 5, in detail phase 610 of FIG. 6 may essentially correspond to phase 510 of FIG. 5. Phase 620 of FIG. 6 may essentially correspond to phase 520 of FIG. 5. In phase 630, responsive to receiving the identity of the cell, the cell the identity corresponds to may be caused to begin transmitting additional reference signals. An example of additional reference signals is cell specific reference signals. In phase 640 a signal quality measurement concerning the identified cell is received from the user equipment, for example a received signal power and/or quality measurement report is received. In some embodiments, the measurement has been conducted based on the additional reference signals. The measurement report may be arranged in a data structure in accordance with a cellular standard such as, for example, global system for mobile communication, GSM, or LTE. Finally in phase 650 an instruction is transmitted, or caused to be transmitted, to the user equipment to include the identified cell in a carrier aggregation operation. The carrier aggregation may be pre-existing and the apparatus performing the illustrated method may be a base station of the primary cell, PCell, of the pre-existing carrier aggregation or alternatively the carrier aggregation may be at least in part newly configured by the signaling of phase 650.

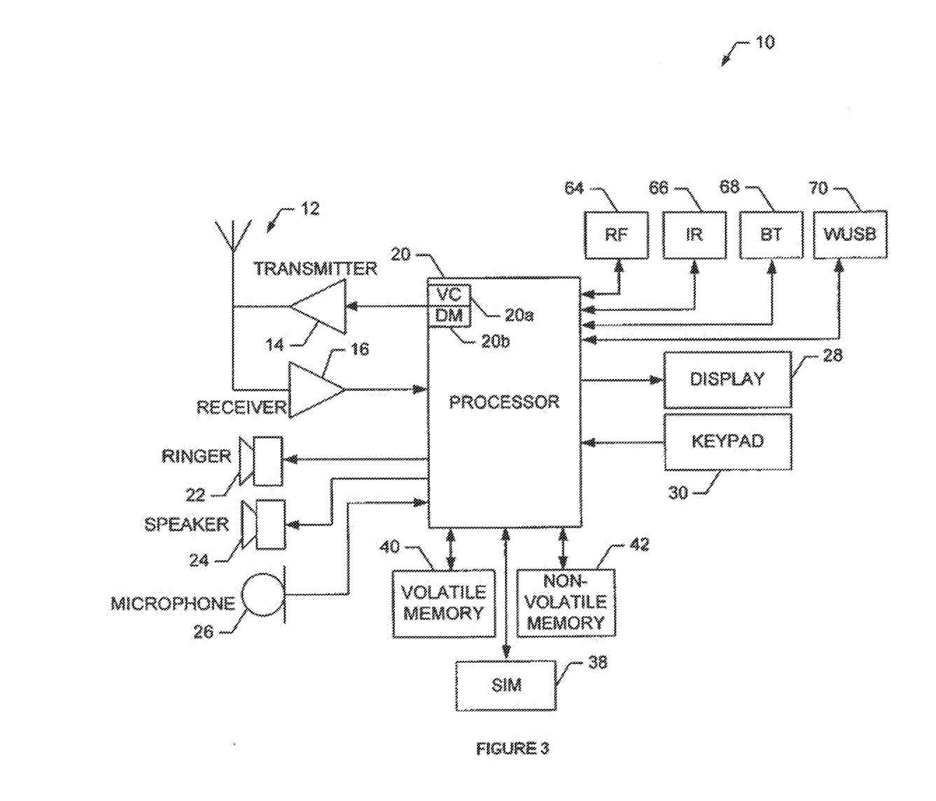

FIG. 3 illustrates a block diagram of an apparatus 10 such as, for example, a mobile terminal, such as for example mobile 110, in accordance with an example embodiment of the invention. While several features of the apparatus are illustrated and will be hereinafter described for purposes of example, other types of electronic devices, such as mobile telephones, mobile computers, portable digital assistants, PDAs, pagers, laptop computers, desktop computers, gaming devices, televisions, routers, home gateways, and other types of electronic systems, may employ various embodiments of the invention.

As shown, the mobile terminal 10 may include at least one antenna 12 in communication with a transmitter 14 and a receiver 16. Alternatively transmit and receive antennas may be separate. The mobile terminal 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example a display or a memory. The processor 20 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit, ASIC, or field programmable gate array, FPGA, or some combination thereof. Accordingly, although illustrated in FIG. 3 as a single processor, in some embodiments the processor 20 comprises a plurality of processors or processing cores. Signals sent and received by the processor 20 may include signaling information in accordance with an air interface standard of an applicable cellular system, and/or any number of different wireline or wireless networking techniques, comprising but not limited to Wi-Fi, wireless local access network, WLAN, techniques such as Institute of Electrical and Electronics Engineers, IEEE, 802.11, 802.16, and/or the like. In addition, these signals may include speech data, user generated data, user requested data, and/or the like. In this regard, the apparatus may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols, Internet Protocol Multimedia Subsystem, IMS, communication protocols, for example, session initiation protocol, SIP, and/or the like. For example, the apparatus may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the mobile terminal may be capable of operating in accordance with 2.5G wireless communication protocols General Packet Radio Service. GPRS, Enhanced Data GSM Environment, EDGE, and/or the like. Further, for example, the apparatus may be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus may be additionally capable of operating in accordance with 3.9G wireless communication protocols such as Long Term Evolution, LTE, or Evolved Universal Terrestrial Radio Access Network, E-UTRAN, and/or the like. Additionally, for example, the apparatus may be capable of operating in accordance with fourth-generation, 4G, wireless communication protocols such as LTE Advanced and/or the like as well as similar wireless communication protocols that may be developed in the future.

Some Narrow-band Advanced Mobile Phone System, NAMPS, as well as Total Access Communication System, TACS, mobile terminal apparatuses may also benefit from embodiments of this invention, as should dual or higher mode phone apparatuses, for example, digital/analog or TDMA/CDMA/analog phones. Additionally, apparatus 10 may be capable of operating according to Wi-Fi or Worldwide Interoperability for Microwave Access, WiMAX, protocols.

It is understood that the processor 20 may comprise circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder, VC, 20a, an internal data modem, DM, 20b, and/or the like. Further, the processor 20 may comprise functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the mobile terminal 10 to transmit and receive web content, such as location-based content, according to a protocol, such as wireless application protocol, WAP, hypertext transfer protocol, HTTP, and/or the like

Apparatus 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. Although not shown, the apparatus may comprise a battery for powering various circuits related to the mobile terminal, for example, a circuit to provide mechanical vibration as a detectable output. The user input interface may comprise devices allowing the apparatus to receive data, such as a keypad 30, a touch display, which is not shown, a joystick, which is not shown, and/or at least one other input device. In embodiments including a keypad, the keypad may comprise numeric 0-9 and related keys, and/or other keys for operating the apparatus.

As shown in FIG. 3, apparatus 10 may also include one or more means for sharing and/or obtaining data. For example, the apparatus may comprise a short-range radio frequency, RF, transceiver and/or interrogator 64 so data may be shared with and/or obtained from electronic devices in accordance with RF techniques. The apparatus may comprise other short-range transceivers, such as, for example, an infrared, IR, transceiver 66, a Bluetooth™ BT, transceiver 68 operating using Bluetooth™ brand wireless technology developed by the Bluetooth™ Special Interest Group, a wireless universal serial bus, USB, transceiver 70 and/or the like. The Bluetooth™ transceiver 68 may be capable of operating according to low power or ultra-low power Bluetooth™ technology, for example, Wibree™, radio standards. In this regard, the apparatus 10 and, in particular, the short-range transceiver may be capable of transmitting data to and/or receiving data from electronic devices within a proximity of the apparatus, such as within 10 meters, for example. Although not shown, the apparatus may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module, SIM, 38, a removable user identity module, R-UIM, and/or the like, which may store information elements related to a mobile subscriber. In addition to the SIM, the apparatus may comprise other removable and/or fixed memory. The apparatus 10 may include volatile memory 40 and/or non-volatile memory 42. For example, volatile memory 40 may include Random Access Memory, RAM, including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, etc., optical disc drives and/or media, non-volatile random access memory, NVRAM, and/or the like. Like volatile memory 40 non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the mobile terminal. For example, the memories may comprise an identifier, such as an international mobile equipment identification, IMEI, code, capable of uniquely identifying apparatus 10..

Without in any way limiting the scope, interpretation, or application of the claims appearing below, a technical effect of one or more of the example embodiments disclosed herein is that energy may be conserved by deactivating transmittion of cell specific reference signals, for example from small cells. Another technical effect of one or more of the example embodiments disclosed herein is that interference is decreased by deactivating transmittion of cell specific reference signals, for example from small cells.

Embodiments of the present invention may be implemented in software, hardware, application logic or a combination of software, hardware and application logic. The software, application logic and/or hardware may reside on memory, a control device or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 3. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a receiver configured to receive information from a serving cell, the receiver being further configured to receive a primary synchronization signal and a secondary synchronization signal from a second cell, the primary synchronization signal conveying a first partial identity of the second cell and the secondary synchronization signal conveying a second partial identity of the second cell;
memory circuitry configured to access stored information enabling the apparatus to derive an identity of the second cell based on the first partial identity and the second partial identity, the memory further being configured to access stored information on a first frequency used by the serving cell and a second frequency used by the second cell, and
at least one processing core configured to cause a transmitter comprised in the apparatus to perform transmitting the identity of the second cell, the transmitting being directed to the serving cell.

2. The apparatus according to claim 1, wherein the apparatus is configured to derive the identity of the second cell based on the first partial identity and second partial identity without using a cell specific reference signal transmitted by the second cell.

3. The apparatus according to claim 1, wherein the information enabling the apparatus to derive an identity of the second cell based on the first partial identity and second partial identity comprises information concerning the second frequency.

4. The apparatus according to claim 1, wherein the apparatus is configured to perform at least one of a signal power and a signal quality measurement of the second cell based on at least one of the primary synchronization signal and the secondary synchronization signal, and to report a result of the at least one measurement to the serving cell.

5. The apparatus according to claim 1, wherein the apparatus is configured to perform at least one of a signal power and a signal quality measurement of the second cell based on a cell specific reference signal received from the second cell.

6. The apparatus according to claim 5, wherein the apparatus is configured to perform the at least one of a signal power and a signal quality measurement responsive to transmitting the identity of the second cell.

7. The apparatus according to claim 5, wherein the apparatus is configured to perform the at least one of a signal power and a signal quality measurement responsive to receiving from the serving cell an indication as to when the second cell will begin transmitting a cell specific reference signal.

8. The apparatus according to claim 5, wherein the apparatus is configured to begin communicating with the serving cell and second cell using a carrier aggregation such that a primary carrier conveys information between the apparatus and the serving cell and a secondary carrier conveys information between the apparatus and the second cell.

9. The apparatus according to claim 8, wherein the apparatus is configured to begin using the carrier aggregation after reporting the result of the at least one of a signal power and a signal quality measurement based on a cell specific reference signal to the serving cell.

10. The apparatus according to claim 1, wherein the apparatus comprises a mobile communication device, the apparatus further comprising an antenna coupled to a radio transceiver and configured to provide signals to the at least one processing core.

11. The apparatus according to claim 10, wherein the apparatus is configured to communicate according to long term evolution standards, as defined by the third generation partnership project.

12. A method, comprising:
receiving information from a serving cell;
receiving a primary synchronization signal and a secondary synchronization signal from a second cell, the primary synchronization signal conveying a first partial identity of the second cell and the secondary synchronization signal conveying a second partial identity of the second cell;
accessing stored information enabling the apparatus to derive an identity of the second cell based on the primary synchronization signal and the secondary synchronization signal, and accessing stored information on a first frequency used by the serving cell and a second frequency used by the second cell, and
transmitting the identity of the second cell, the transmitting being directed to the serving cell.

13. The method according to claim 12, wherein deriving comprises deriving the identity of the second cell based on the first partial identity and second partial identity without using a cell specific reference signal transmitted by the second cell.

14. The method claim 12, wherein the information enabling the derivation of an identity of the second cell based on the first partial identity and second partial identity comprises information concerning the second frequency.

15. The method according to claim 12, further comprising performing at least one of a signal power and a signal quality measurement of the second cell based on at least one of the primary synchronization signal and the secondary synchronization signal, and reporting a result of the signal power and/or quality measurement to the serving cell.

16. The method according to claim 12, further comprising performing at least one of a signal power and a signal quality measurement of the second cell based on a cell specific reference signal received from the second cell.

17. An apparatus, comprising:
at least one processor; and
at least one memory including computer program code
the at least one memory and the computer program code configured to, with the at least one processor, cause the apparatus to perform at least the following:
transmit to a user equipment information enabling the user equipment to derive an identity of a cell based on a primary synchronization signal and a secondary synchronization signal of the cell;
receive an identity of the cell from the user equipment; and
transmit to the user equipment an instruction to to begin communicating with the apparatus and the cell using a carrier aggregation such that a primary carrier conveys information between the user equipment and the apparatus and a secondary carrier conveys information between the apparatus and the cell.

18. A method, comprising:
transmitting, from an apparatus, to a user equipment information enabling the user equipment to derive an identity of a cell based on a first partial identity of the cell conveyed by a primary synchronization signal and a second partial identity of the cell conveyed by a secondary synchronization signal of the cell;
receiving an identity of the cell from the user equipment, and
transmitting to the user equipment an instruction to begin communicating with the apparatus and the cell using a carrier aggregation such that a primary carrier conveys information between the user equipment and the apparatus and a secondary carrier conveys information between the apparatus and the cell.

19. The method according to claim 18, comprising causing transmission of a cell specific reference signal from the cell to be activated responsive to the receipt of the identity of the cell.

20. The method according to claim 19, comprising scheduling data to be transmitted via the cell to the user equipment in response to feedback information received from the user equipment.

21. (canceled)
